(19) United States
(12) Patent Application Publication
(10) Pub. No.: US 2011/0290836 A1
(43) Pub. Date: Dec. 1, 2011

(54) ROOF RACK

(76) Inventor: JACK C.T. SHEN, Taichung County (TW)

(21) Appl. No.: 12/789,371

(22) Filed: May 27, 2010

(51) Int. Cl. B60R 9/10; B60R 9/048; B60R 9/045

(52) U.S. Cl. 224/319; 224/324; 224/325

(57) ABSTRACT

The roof rack of the present invention includes a frame, a first carrier, a second carrier and at least one fixation device. The frame defines a longitudinal direction and has a front and a rear. The first carrier is disposed on the rear of the frame. The second carrier is disposed on the front of the frame. At least one of the carriers is movable along the longitudinal direction on the frame. The fixation device is adapted to selectively fix the at least one movable carrier to the frame. Thereby, the roof rack of the present invention is adapted to carry bicycles with alternative wheel distances thereon.

### BACKGROUND OF THE INVENTION

1. Field of the Invention

The present invention relates to a roof rack for a vehicle.

2. Description of the Prior Art

A roof rack for vehicle is adapted to be installed atop the vehicle to carry, for example, bicycle(s). However, the wheel distances of the bicycles vary from case to case. Thus the conventional roof rack has trouble carrying bicycles with different wheel distances. Besides, the conventional roof rack includes a longitudinal rack having a V-shaped profile for the bicycle wheels to rest thereon. Therefore, fastening belts are further needed to secure the bicycle(s) on the roof rack. Yet the fastening belts provide insufficient strength to prohibit the bicycle(s) from moving along the longitudinal direction of the roof rack, which is a potential threat to the driving safety.

The present invention is, therefore, arisen to obviate or at least mitigate the above mentioned disadvantages.

### SUMMARY OF THE INVENTION

The main object of the present invention is to provide a roof rack to securely carry a bicycle with alternative wheel distance.

Another main object of the present invention is to provide a roof rack which can prohibit the longitudinal movement of the bicycle.

To achieve the above and other objects, the roof rack of the present invention includes a frame, a first carrier, a second carrier and at least one fixation device. The frame defines a longitudinal direction and has a front and a rear. The first carrier is disposed on the rear of the frame, and the second carrier is disposed on the front of the frame. At least one of the carriers is movable along the longitudinal direction on the frame. The fixation device is adapted to selectively fix the at least one movable carrier to the frame. As such, the distance between the carriers is adjustable to correspond to the wheel distance of a bicycle to be supported on the roof rack.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective drawing showing a usage state of a roof rack of the present invention;

FIG. 2 is a perspective drawing showing a roof rack of the present invention;

FIG. 3 is a partial breakdown drawing showing a roof rack of the present invention;

FIG. 3A is a perspective enlargement of a teeth bar and teeth shank of the present invention;

FIG. 4 is a profile showing a roof rack of the present invention;

FIG. 4A is a partial enlargement of FIG. 4;

FIG. 5 is another profile showing a roof rack of the present invention in which a releasing rod locates at the third position;

FIG. 6 is another profile showing a roof rack of the present invention in which a releasing rod locates at the fourth position;

FIG. 7 is a profile showing a roof rack of the present invention in which a teeth shank locates at a second position.

### DETAILED DESCRIPTION OF THE PREFERRED EMBODIMENTS

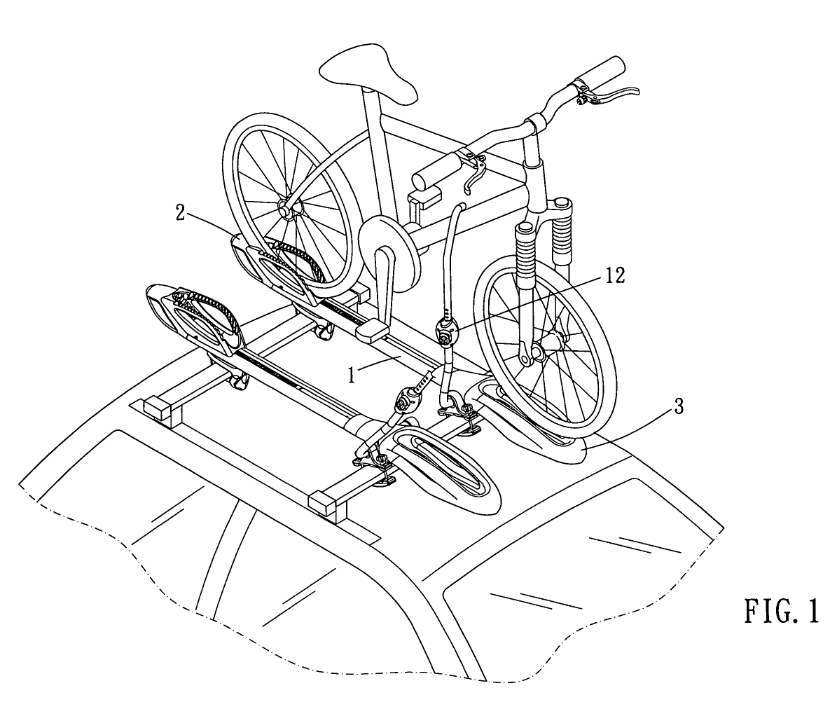

Please refer to FIG. 1. A roof rack of the present invention is installed on a roof of a vehicle and is adapted to support a bicycle thereon.

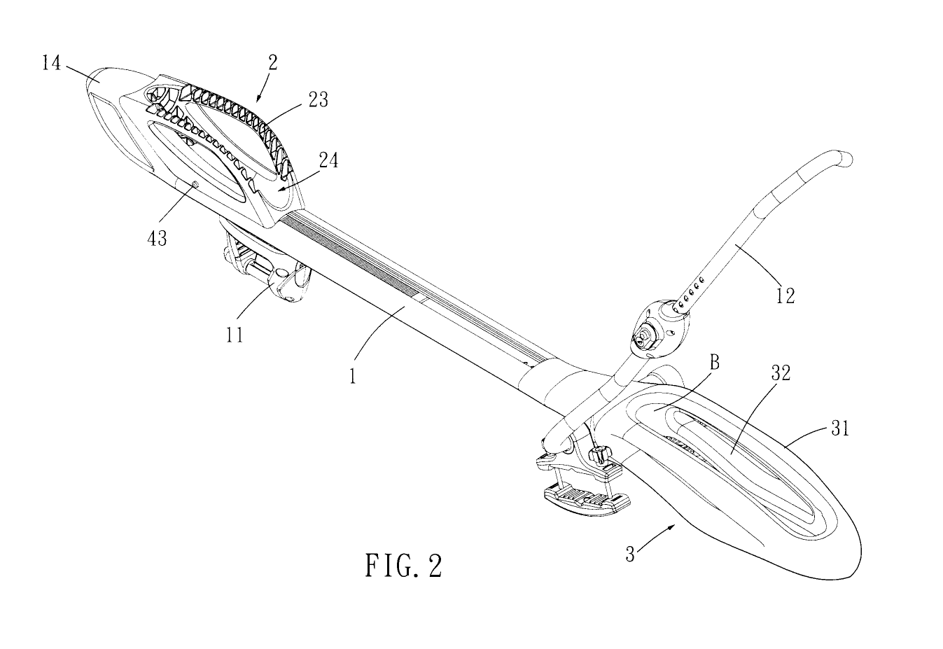

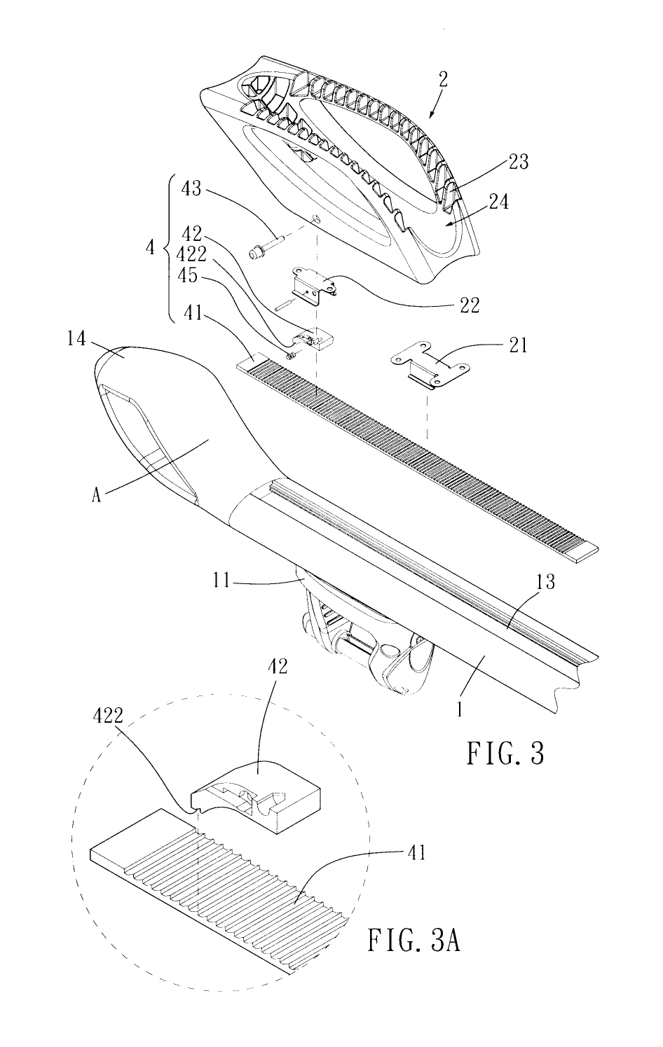

Please refer to FIG. 2 and FIG. 3. The roof rack of the present invention includes a frame 1, a first carrier 2, a second carrier 3 and a fixation device 4.

The frame 1 is adapted to install on the roof of the vehicle, and the frame 1 defines a longitudinal direction and has a front and a rear. At least one clamping tool 11 can be disposed beneath the front and rear of the frame respectively, so as to fix the frame 1 on the vehicle roof. A stopping member 14 is disposed on the rear of the frame 1. An inner surface of the stopping member 14 is an arc stopping surface A. A rotatable abutting rod 12 can be further disposed on the frame 1 to secure the bicycle.

The first carrier 2 is disposed on the rear of the frame 1, and the second carrier 3 is disposed on the front of the frame 1. And the carriers 2, 3 are adapted to support the wheels, i.e. a front wheel and a rear wheel, of a bicycle respectively. The first carrier 2 is slidably disposed on the frame along the longitudinal direction, and the second carrier 3 is fixedly disposed on the frame. In another possible embodiment of the present invention, the first carrier can be fixed, and the second carrier can be, on the other hand, slidable with respect to the first carrier. In yet another possible embodiment of the present invention, both the carriers can be slidable, thus two fixation devices are needed to selectively fix the carriers on the frame respectively. The frame 1 has a sliding slot 13. And a sliding shank 21, which is fixedly disposed on the first carrier 2, is slidably received in the sliding slot 13. As such, the first carrier 2 is also slidable along the sliding slot 13 along with the sliding shank 21. The first carrier 2 has two side abutting surfaces 23 and a first positioning slot 24 defined by the side abutting surfaces 23, in which the first positioning slot 24 has two open ends and is adapted to support the rear wheel of the bicycle. The second carrier 3 has a rear abutting surface B, two side abutting surfaces 31 and a second positioning slot 32 defined between the rear abutting surface B and the side abutting surfaces 31, in which the second positioning slot 32 is adapted to support the front wheel of the bicycle.

The fixation device 4 is adapted to selectively fix the first carrier 2 to the frame 1. The fixation device 4 includes a teeth bar 41, a teeth shank 42 and a movable element. The teeth bar 41 is fixedly disposed on the frame 1. Preferably, the teeth bar 41 is disposed in the sliding slot 13. The teeth shank 42 is disposed on the first carrier 2, and the teeth shank 42 is formed with ratchet teeth 422 at a distal end thereof. The teeth shank 42 is movable between a first position and a second position with respect to the frame 1. More specifically, the first carrier 2 may further include a positioning base 22 to which the teeth shank 42 is pivoted, so that the teeth shank 42 is pivotable between the first and second positions. In other possible embodiments of the present invention, the teeth shank 42 may be linearly slidably disposed on the first carrier 2. The movable element is a releasing rod 43 movably disposed on the first carrier 2 between a third position and a fourth position as the releasing rod 43 is pressed upon. Preferably, a resilient member 45 is provided to abut against the releasing rod 43 to bias the releasing rod 43 toward the third position.

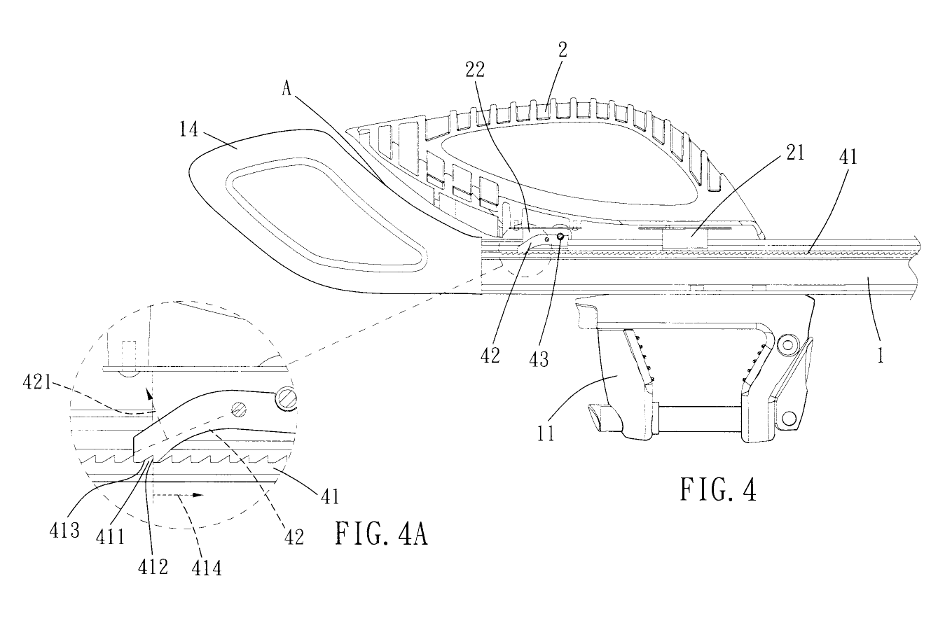

Please refer to FIG. 4. The teeth shank 42 locates at the first position spontaneously, either by the effort of gravity or an addition spring, so that the teeth shank 42 engages with the teeth bar 41. Please refer to FIG. 4A. The teeth bar 41 has a plurality of ratchet teeth 411. Each tooth has a vertical surface 412 close to the second carrier 3 and a slanted surface 413 away from the second carrier 3. A first direction 414 is defined perpendicular from the vertical surface 412 to the second carrier 3, and a second direction 421 is defined from the first position toward the second position of the teeth shank 42. An included angle between the first direction and the second direction is no smaller than 90 degrees. As such, the teeth shank 42 can only be pushed to move toward the second carrier 3 as the teeth shank 42 engages with the teeth bar 41, yet the movement opposite to the second carrier 3 is prohibited due to the abutment of the vertical surface 412.

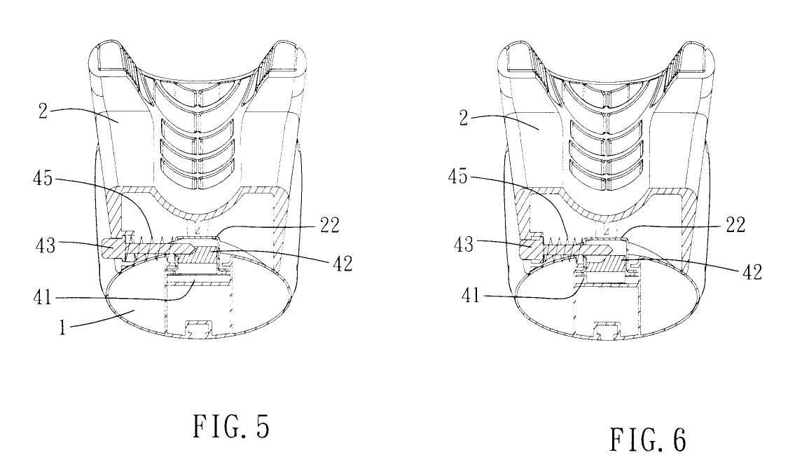

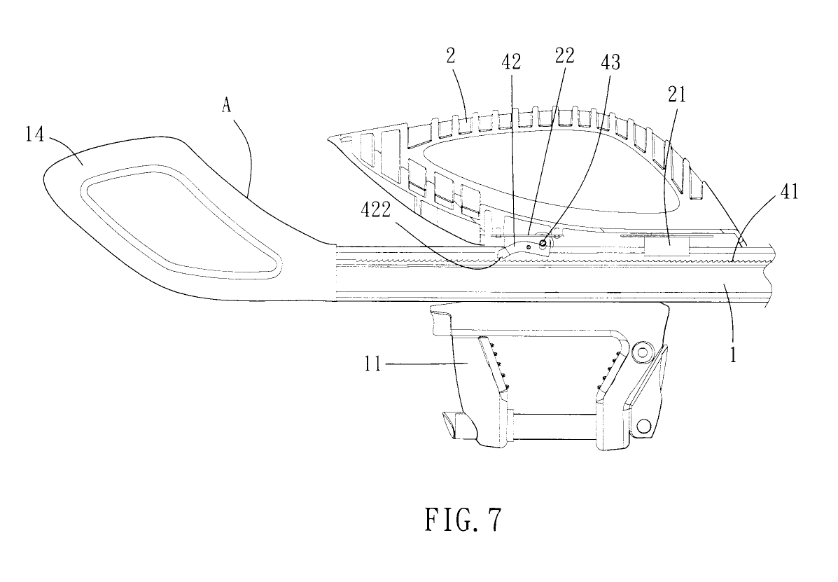

Please refer to FIG. 5. The releasing rod 43 does not abut against the teeth shank 42 as the releasing rod 43 locates at the third position. Please refer to FIG. 6 and FIG. 7. As the releasing rod 43 is moved toward the fourth position, the releasing rod 43 pushes the teeth shank 42 toward the second position, disengaging the teeth shank 42 from the teeth bar 41. As such, the first carrier 2 is free to move rearward.

Thereby, the distance between the carriers of the present invention is adjustable to correspond to the wheel distance of the bicycle to be supported on the roof rack. The ratchet teeth of the teeth shank and the teeth bar help the user to quickly adjust the distance between the carriers in one direction while prohibiting the movement of one of the carrier in the opposite direction. To release the engagement of the teeth members, the user can simply press the releasing rod such that the carrier can freely move with respect to the frame. Further, the rear abutting surface of the carrier helps support the wheel in the longitudinal direction. Thus the bicycle can be better secured on the roof rack.

What is claimed is:

1. A roof rack, comprising
a frame, defining a longitudinal direction and having a front and a rear;
a first carrier, disposed on the rear of the frame;
a second carrier, disposed on the front of the frame, wherein at least one of the carriers is movable along the longitudinal direction on the frame;
at least one fixation device, being adapted to selectively fix the at least one movable carrier to the frame.

2. The roof rack of claim 1, wherein the fixation device comprises a teeth bar, a teeth shank and a movable element, the teeth bar is fixedly disposed on the frame, the teeth shank is disposed on the movable carrier, the teeth shank being movable between a first position and a second position, the teeth shank engages with the teeth bar as the teeth shank locates at the first position, the movable element selectively abuts against the teeth shank to move the teeth shank toward the second position, so as to disengage the teeth shank from the teeth bar.

3. The roof rack of claim 1, wherein at least one front clamping tool is disposed beneath the front of the frame, at least one rear clamping tool is disposed beneath the rear of the frame, the frame further has a rotatable abutting rod.

4. The roof rack of claim 1, wherein each carrier has a rear abutting surface, two side abutting surfaces and a positioning slot defined between the rear abutting surface and the side abutting surfaces.

5. The roof rack of claim 2, wherein the frame further has a sliding slot, a sliding shank is fixedly disposed on the first carrier, the sliding shank is slidably received in the sliding slot, the teeth bar is disposed in the sliding slot.

6. The roof rack of claim 2, wherein the teeth bar has a plurality of teeth, each tooth has a vertical surface close to the second carrier and a slanted surface away from the second carrier, a first direction is defined perpendicular from the vertical surface to the second carrier, a second direction is defined from the first position toward the second position of the teeth shank, an included angle between the first direction and the second direction is no smaller than 90 degrees.

7. The roof rack of claim 2, wherein the movable element includes a releasing rod, the releasing rod is movably disposed on the first carrier between a third position and a fourth position, the releasing rod abuts against the teeth shank as the releasing rod locates at the fourth position, so as to move the teeth shank toward the second position.

8. The roof rack of claim 7, wherein at least one front clamping tool is disposed beneath the front of the frame, at least one rear clamping tool is disposed beneath the rear of the frame, the frame further has a rotatable abutting rod.

9. The roof rack of claim 7, wherein each carrier has a rear abutting surface, two side abutting surfaces and a positioning slot defined between the rear abutting surface and the side abutting surfaces.
